(19) United States
(12) Patent Application Publication
(10) Pub. No.: US 2014/0200060 A1
(43) Pub. Date: Jul. 17, 2014

(54) INTERACTION DISPLAY SYSTEM AND METHOD THEREOF

(71) Applicant: MediaTek Inc., Hsin-Chu (TW)

(72) Inventors: Chi-Ling WU, Taipei City (TW); Yu-Pao TSAI, Kaohsiung City (TW); Yu-Lin CHANG, Taipei City (TW)

(73) Assignee: MediaTek Inc., Hsin-Chu (TW)

(21) Appl. No.: 14/200,232

(22) Filed: Mar. 7, 2014

Related U.S. Application Data
(63) Continuation of application No. 13/466,960, filed on May 8, 2012.

(51) Int. Cl. G06F 3/01; A63F 13/00; G06F 3/03

(52) U.S. Cl. CPC G06F 3/011; G06F 3/0304; A63F 13/005; A63F 2300/1087; A63F 2300/8076; A63F 2300/8082
USPC 463/5; 345/156

(57) ABSTRACT

An interaction display system applied in a mobile device is provided. The system has a camera unit configured to capture images of a scene; a motion detection unit configured to detect motions of the mobile device during capturing the images; and a processing unit coupled to the camera unit and the motion detection unit, configured to estimate a geometry of the scene according to the captured images and the detected motions.

### BACKGROUND OF THE INVENTION

### CROSS REFERENCE TO RELATED APPLICATIONS

This application is a divisional application and claims the benefit of U.S. non-provisional application Ser. No. 13/466,960, which was filed on May 8, 2012 and entitled “Interaction Display System and Method Thereof” and is incorporated herein by reference.

### FIELD OF THE INVENTION

The present invention relates to an interaction display system, and in particular relates to an interaction display system and method utilizing both front-facing and rear-facing cameras simultaneously in a mobile device.

### DESCRIPTION OF THE RELATED ART

FIGS. 1A-1B illustrate a diagram of a mobile device with a front-facing camera and a rear-facing camera. As technologies develop, mobile devices equipped with camera(s) have grown popular. The mobile device 100, such as a smart phone, is equipped with a front-facing camera 110, a rear-facing camera 120 and a display screen 140, as illustrated in FIG. 1A. The front-facing camera 110 may capture images of the user and the rear-facing camera 120 may capture real scenes. However, there is a multiplexer 150 deployed in the mobile device 100 for selecting a single data channel from the front-facing camera 110 or the rear-facing camera 120, as illustrated in FIG. 1B. That is, images captured or video recorded from one camera are transmitted to the processing unit 130, and then the display screen 140 for display. The processing unit 130 receives and processes one data channel of either the front-facing camera or rear-facing camera at a time, so even though there are two cameras 110 and 120, the processing unit 130 only needs the capability of processing a single data channel.

### BRIEF SUMMARY OF THE INVENTION

A detailed description is given in the following aspects with reference to the accompanying drawings.

In one aspect, an interaction display system applied in a mobile device is provided, wherein the interaction display system comprises a camera unit configured to capture images of a scene. And the interaction display system comprises: a motion detection unit configured to detect motions of the mobile device during capturing the images; and a processing unit coupled to the camera unit and the motion detection unit, configured to estimate a geometry of the scene according to the captured images and the detected motions.

In yet another aspect, an interaction display method applied in an interaction display system of a mobile device is provided, the interaction display system comprises a camera, a motion detection unit, and a processing unit, and the method comprises: capturing images of a scene by a camera; detecting motions of the mobile device by the motion detection unit during capturing the images; and estimating a geometry of the scene according to the captured images and the detected motions.

In yet another aspect, an interaction display method applied in an interaction display system of a mobile device is provided, the interaction display system comprises a first camera facing a first side of the mobile device, a second camera facing a second side different from the first side of the mobile device, a motion detection unit, and a processing unit, the method comprises: capturing first images of a user by the first camera; capturing second images of a scene by the second camera; detecting first motions of the mobile device by the motion detection unit during capturing the first images and detecting second motions of the mobile device during capturing the second images; estimating a first geometry of the user according to the first images and the first motions, and estimating a second geometry of the scene according to the second images and the second motions; and computing and producing interaction results utilizing the estimated first geometry and second geometry, and at least one of the first images and at least one of the second images simultaneously captured by the first camera and the second camera.

In yet another aspect, an interaction display system applied in a mobile device is provided, the interaction display system comprises a first camera and a second camera, wherein the first camera faces to a first side of the mobile device and is configured to capture first images of a user, and the second camera faces to a second side different from the first side of the mobile device and is configured to capture second images of a scene; the interaction display system comprises: a motion detection unit configured to detect first motions of the mobile device during capturing the first images and detect second motions of the mobile device during capturing the second images; and a processing unit coupled to the first camera, the second camera and the motion detection unit, configured to estimate a first geometry of the user according to the first images and the first motions, estimate a second geometry of the scene according to the second images and the second motions, and compute and produce interaction results utilizing the estimated first geometry and second geometry, and at least one of the first images and at least one of the second images simultaneously captured by the first camera and the second camera.

### BRIEF DESCRIPTION OF THE DRAWINGS

The present invention can be more fully understood by reading the subsequent detailed description and examples with references made to the accompanying drawings, wherein:

FIGS. 1A-1B illustrate diagrams of a conventional mobile device;

FIGS. 2A-2C illustrate block diagrams of the interaction display system in a mobile device according to embodiments of the invention;

FIG. 3A illustrates a diagram of a shooting game application executed on the mobile device according to an embodiment of the invention;

FIGS. 3B-3C illustrate diagrams of a shooting direction of the virtual object according to an embodiment of the invention;

FIG. 3D illustrates a diagram of a shooting direction of the virtual object according to another embodiment of the invention;

FIG. 3E illustrates a diagram of the target object according to yet another embodiment of the invention;

FIGS. 4A-4B illustrate diagrams of the shooting game application according to yet another embodiment of the invention;

FIG. 5 illustrates a diagram of the mobile device with a social network according to an embodiment of the invention;

FIG. 6 illustrates an interaction display method applied in the interaction display system of the mobile device according to an embodiment of the invention; and

FIG. 7 illustrates an interaction display method applied in the interaction display system of the mobile device according to another embodiment of the invention.

FIGS. 8A and 8B illustrate a diagram of the motion of the mobile device according to an embodiment of the invention.

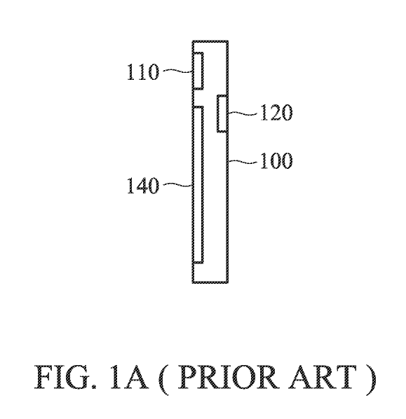

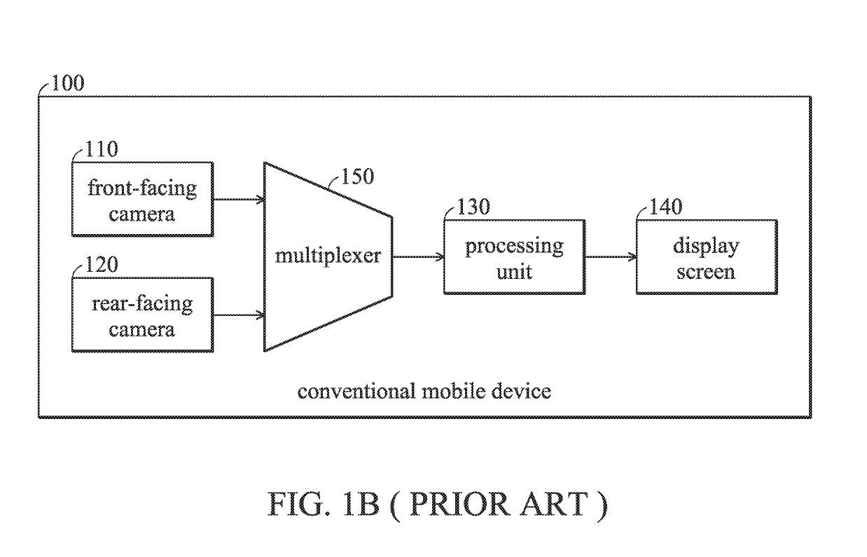

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

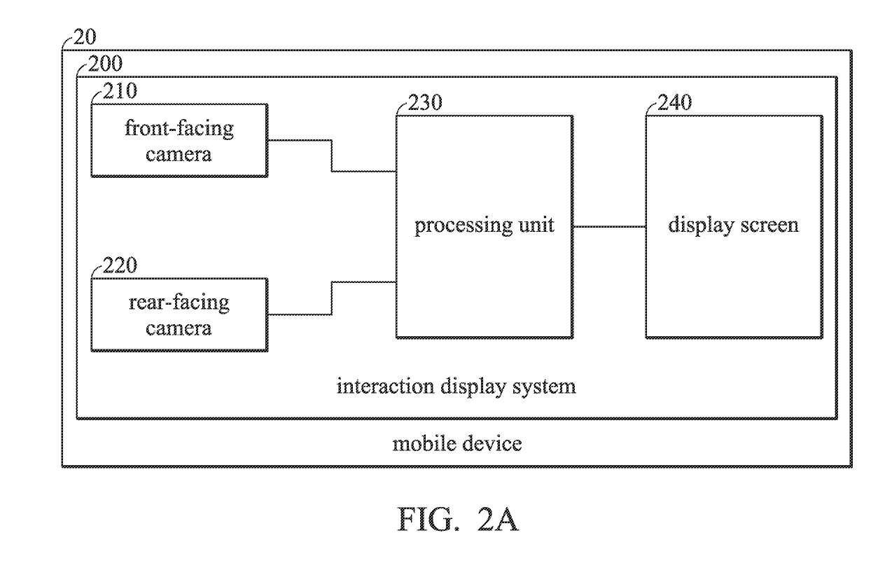

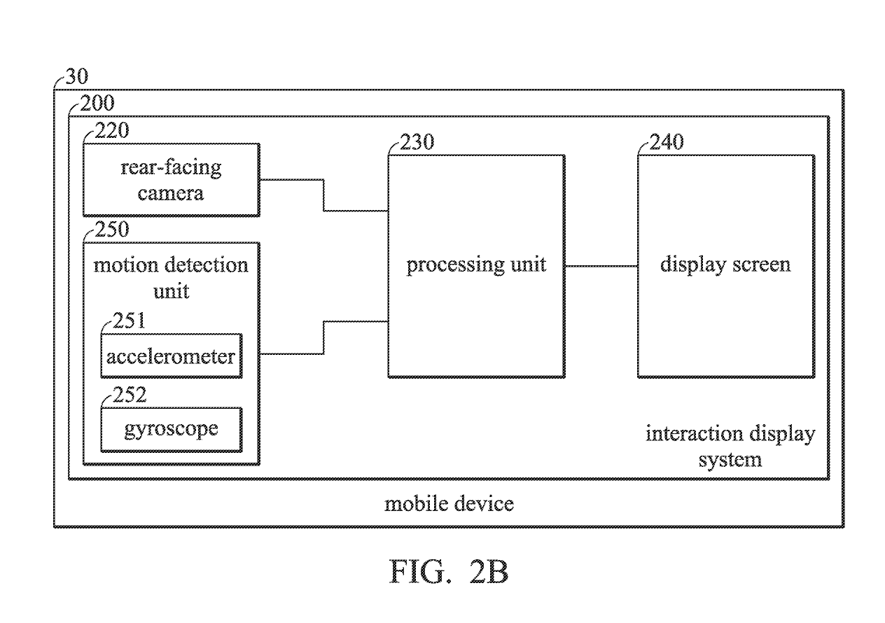

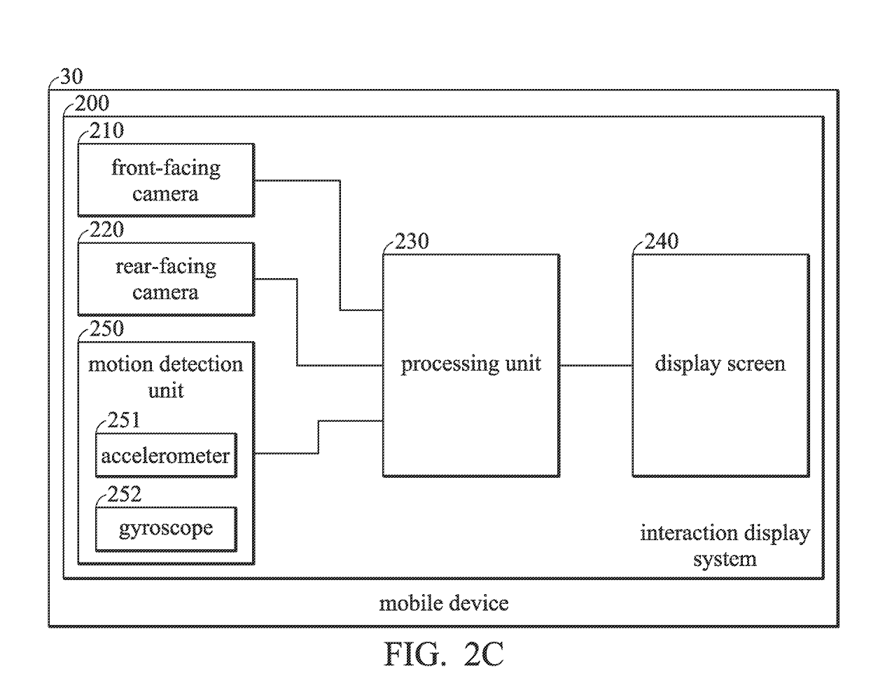

FIG. 2A illustrates a block diagram of an interaction display system of a mobile device according to an embodiment of the invention. The interaction display system 200 in the mobile device 20 may comprise a front-facing camera 210, a rear-facing camera 220, a processing unit 230 and a display screen 240. The front-facing camera 210 and the rear-facing camera 220 are configured to continuously capture images from opposite sides of the interaction display system 200, respectively. For example, the front-facing camera 210 is disposed at a first side (e.g. the same side with the display screen 240) of the mobile device 20 to capture first images of a user (e.g. user's actions, such as gestures, movements, or facial expressions) continuously, and the rear-facing camera 220 is disposed at a second side opposite to the first side of the mobile device 20 to capture second images of a scene continuously. Alternatively, the front-facing camera 210 and the rear-facing camera 220 are not necessary to be disposed in opposite sides. For examples, the front-facing camera 210 may be arranged to focus on objects in different views other than the opposite view of the rear-facing camera 220. The front-facing camera 210 may face a first side of the mobile device 20 to capture first images (e.g. gestures of the user), and the rear-facing camera 220 may face a second side different from the first side of the mobile device 20 to capture second images (e.g. the scene). The processing unit 230 is configured to perform interactions by utilizing at least one of the first images and at least one of the second images captured simultaneously by the first camera and the second camera. In addition, the processing unit 230 may further generate interaction images according to the first images and the second images, and display the generated interaction images on the display screen 240 (i.e. the details will be described below). In an embodiment, the processing unit 230 may be a central processing unit (CPU) or other equivalent circuits for performing the same, but the invention is not limited thereto. It should be noted that when compared with the conventional mobile device 100, a multiplexer deployed to select one data channel from one camera for the processing unit 230 can be bypassed when two cameras are both turned on for interaction applications. In other words, the processing unit 230 can be directly coupled to the front-facing camera 210 and the rear-facing camera 220 and is capable of processing two data channels simultaneously. Accordingly, the processing unit 230 may utilize the captured first and second images from both the front-facing camera 210 and the rear-facing camera 220, respectively, to compute and produce interaction results of the interactions between the user and the scene.

FIG. 2B illustrates a diagram of the mobile device according to another embodiment of the invention. When a user uses the mobile device 30 to capture images of a scene, motions of the mobile device 30 are incurred by tremors of the user's hand. Thus, the motions can be used to estimate the geometry of the scene. As illustrated in FIG. 2B, the interaction display system 200 may comprises a motion detection unit 250 coupled to the processing unit 230 to detect the motion of the mobile device 30. Note that there is only one camera (i.e. rear-facing camera 220) disposed in the mobile device 30 for capturing images of a scene. Generally, the motion of the mobile device 30 can be represented by an acceleration index and an orientation index. Specifically, the motion detection unit 250 may comprise an accelerometer 251 and a gyroscope 252. The accelerometer 251 is configured to detect the acceleration of the mobile device 30. The gyroscope 252 is configured to detect the orientation of the mobile device 30. The processing unit 230 may further calculate a transformation matrix Mₜ by using the detected acceleration and orientation (i.e. the detected motions) from the accelerometer 251 and the gyroscope 252, respectively. The projection matrix Mproj can be expressed as the following equation:

$${M}_{proj} = [ \begin{matrix}{f}_{x} & 0 & {S}_{x} \\ 0 & {f}_{y} & {S}_{y} \\ 0 & 0 & 1\end{matrix} ]$$

where (Sₓ, S_{y}) denotes the coordinate of the principal point wherein the optic axis intersects the image plane; and ƒₓ and ƒ_{y} denote the scaling factors in horizontal and vertical direction, respectively.

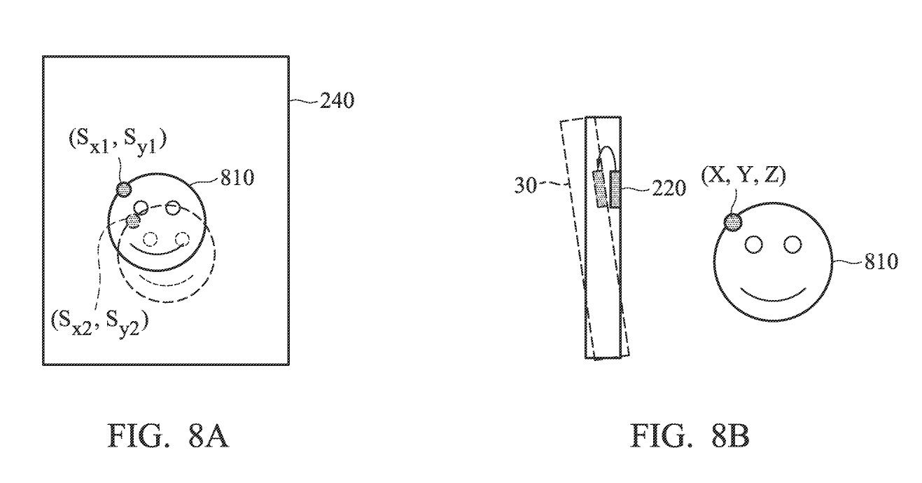

Then, the processing unit 230 may further estimate the geometry of the scene by using the transformation matrix Mt with a predetermined projection matrix Mₚᵣₒⱼ and a predetermined camera viewing matrix M_{camera}. The camera viewing matrix M_{camera} can be expressed as the following equation: M_{camera}=[I|0], wherein I indicates an identity matrix in 3×3 dimensions. Specifically, referring to FIG. 2B, FIG. 8A and FIG. 8B, the rear-facing camera 220 may capture at least two images due to the tremors of the user's hand. The width and the height of the display screen 240 are W and H, respectively. The initial coordinate of the object 810 is (S₁ₓ, S_{y1}). After the movement, the coordinate of the object 810 is (Sₓ₂, S_{y2}). Accordingly, the processing unit 230 may calculate the following six equations based on the relationship between each parameters:

$$\begin{matrix}{M}_{proj} {M}_{camera} [ \begin{matrix}x \\ y \\ z \\ 1\end{matrix} ] = [ \begin{matrix}{x}_{1}^{′} \\ {y}_{1}^{′} \\ {z}_{1}^{′} \\ 1\end{matrix} ] & ( 1 ) \\ \frac{{x}_{1}^{′}}{{z}_{1}^{′}} \cdot W = {S}_{x 1} & ( 2 ) \\ \frac{{y}_{1}^{′}}{{z}_{1}^{′}} \cdot H = {S}_{y 1} & ( 3 ) \\ {M}_{proj} {M}_{t} {M}_{camera} [ \begin{matrix}x \\ y \\ z \\ 1\end{matrix} ] = [ \begin{matrix}{x}_{2}^{′} \\ {y}_{2}^{′} \\ {z}_{2}^{′} \\ 1\end{matrix} ] & ( 4 ) \\ \frac{{x}_{2}^{′}}{{z}_{2}^{′}} \cdot W = {S}_{x 2} & ( 5 ) \\ \frac{{y}_{2}^{′}}{{z}_{2}^{′}} \cdot H = {S}_{y 2} & ( 6 )\end{matrix}$$

Accordingly, the processing unit 230 may calculate five unknown parameters (e.g. x, y, z, z₁′ and z₂′) from the six equations (1) to (6), wherein (x, y, z) denotes the calculated coordinate of the object in horizontal, vertical and the normal directions based on the display screen 240, respectively, as illustrated in FIG. 8B. Subsequently, the processing unit 230 may obtain the geometry of the scene by calculating the coordinate of every pixel in the scene.

FIG. 2C illustrates a diagram of the mobile device according to yet another embodiment of the invention. It should be noted that the processing unit 230 is capable of estimating the geometry of the scene by using only one camera (e.g. the rear-facing camera 220 in FIB. 2B). Accordingly, referring to FIG. 2C, the processing unit 230 may further generate interaction images according to the estimated geometry and the captured images of the user from another camera (e.g. the front-facing camera 210 in FIG. 2C), thereby performing interactions between the user and the scene.

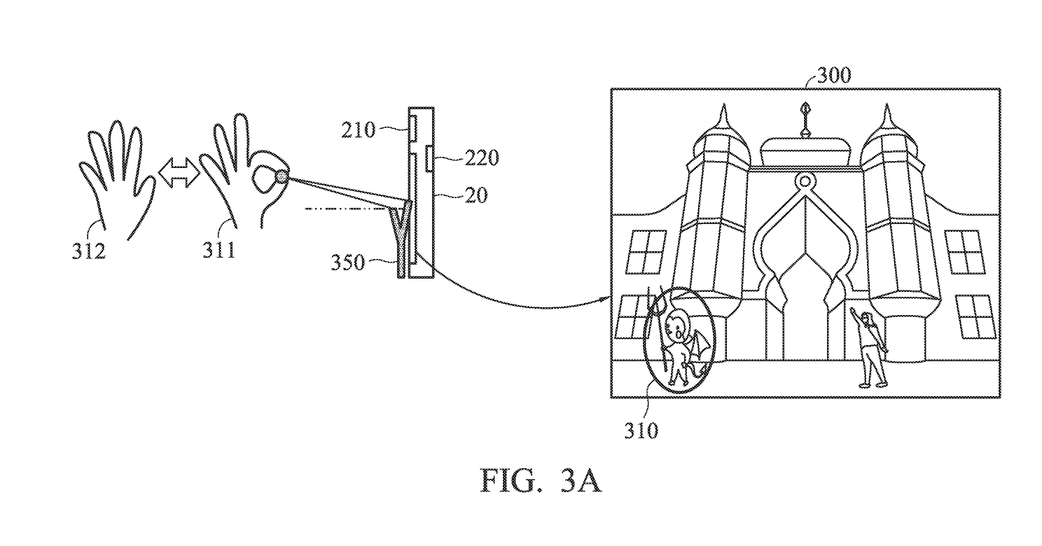

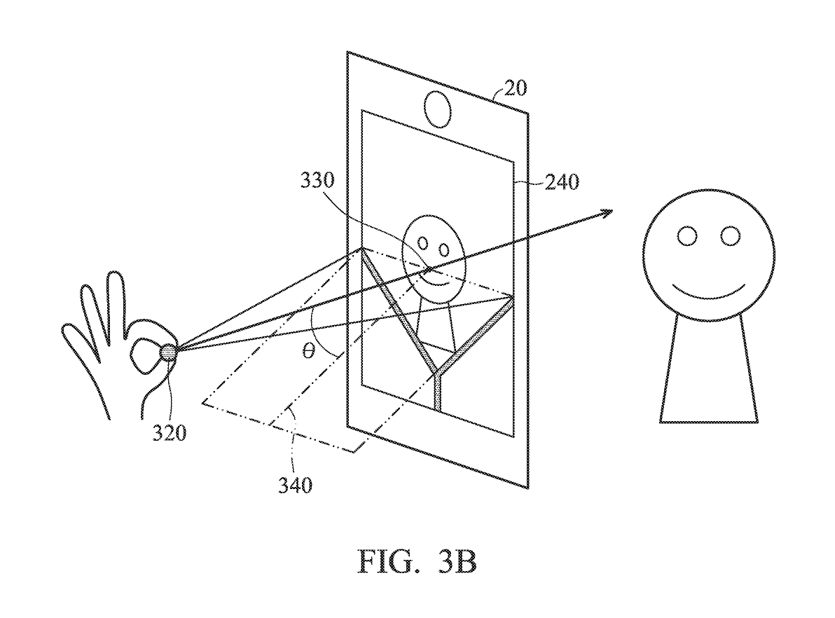

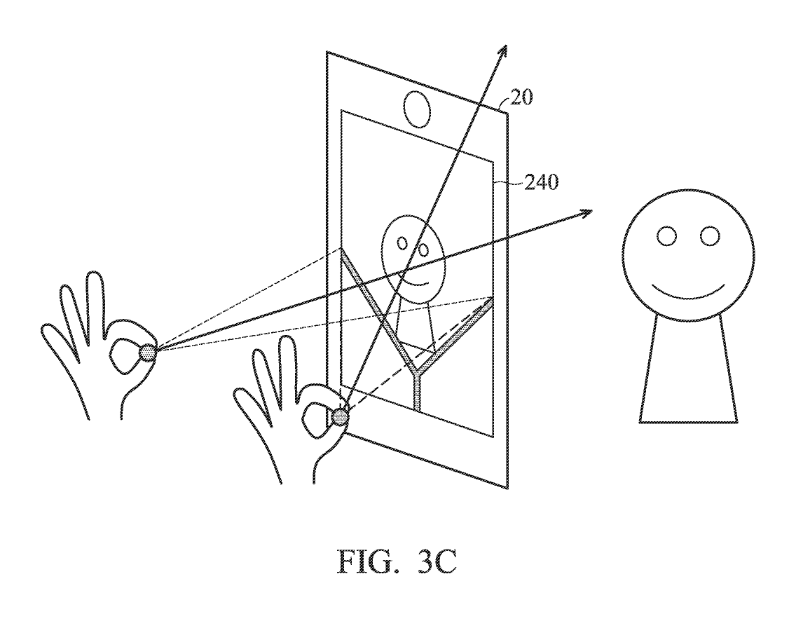

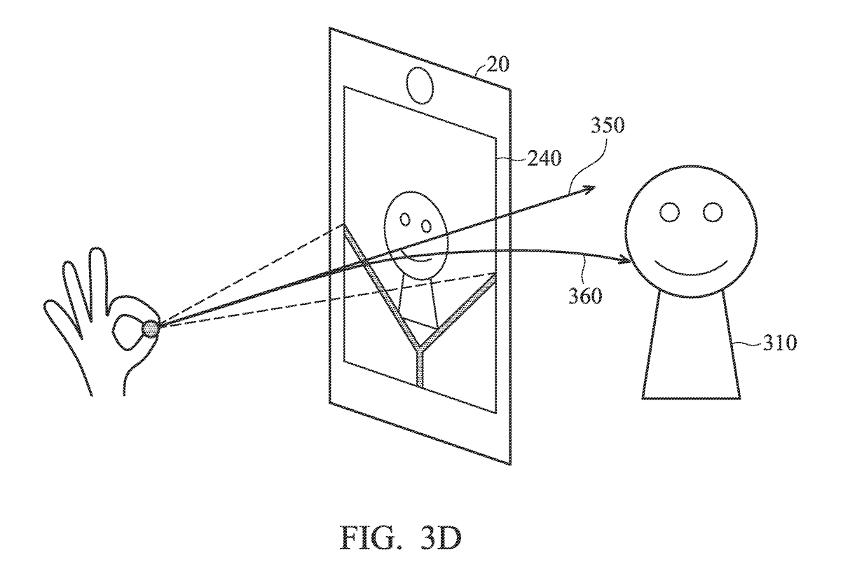

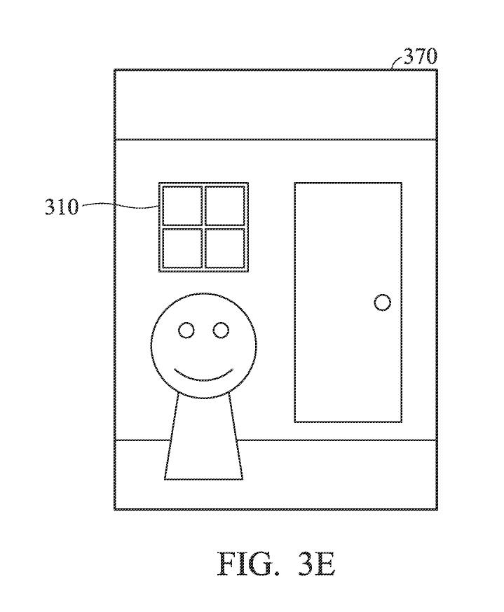

FIG. 3A illustrates a diagram of a shooting game application executed on the mobile device according to an embodiment of the invention. Referring to FIGS. 2A and 3A, the front-facing camera 210 may keep capturing images of the gestures of the user, and the rear-facing camera 220 may keep capturing images of the scene 300. The processing unit 230 may further draw a target object 310 (i.e. a virtual object) on the images of the scene. In the shooting game application illustrated in FIG. 3A, the user may use different gestures (e.g. gestures 311 and 312) to control the virtual slingshot 350 simulated by the processing unit 230 on the display screen 240. That is, the user may shoot (or throw) a projectile (e.g. a virtual stone, bullet, etc.) to the target object 310 by using the virtual slingshot 350.

FIGS. 3B-3C illustrate a diagram of a shooting direction of the virtual object according to an embodiment of the invention. For example, the user may use the connected point of fingertips (i.e. the connected point 320) to pull the string of the virtual slingshot. The shooting strength of the string may be decided by the distance between the connected point 320 and the center 330 of the display screen 240. The shooting direction of the projectile may be decided by the angle θ between the connected point 320 and the normal line 340 of the display screen 240. The user may also preset the elastic coefficient of the string of the virtual slingshot, and thus the power of the string can be decided by both the shooting strength and the elastic coefficient of the string. Accordingly, the user may control the power and shooting direction of the string of the virtual slingshot to aim different targets, as illustrated in FIG. 3C. That is, the processing unit 230 may computes the power and the shooting direction of the string of the virtual slingshot according to gestures in the first images captured by the front-facing camera 210.

It should be noted that the front-facing camera 210 and the rear-facing camera 220 can be stereo cameras or depth cameras, respectively. Also, the display screen 240 can be a stereoscopic screen and the generated interaction images can be stereoscopic images. Specifically, the stereoscopic interaction images displayed on the display screen (i.e. stereoscopic screen) are converted from the captured images (i.e. two-dimensional images or stereoscopic images) by the processing unit 230. The technologies for converting two-dimensional images to stereoscopic images are well-known for those skilled in the art, and the details will not be described here.

Alternatively, the rear-facing camera 220 may capture images with a built-in flashlight (not shown in FIGS. 2A-2C), and the processing unit 230 may estimate the geometry of the scene by calculating the luminance of the scene cause by the light emitted from the built-in flashlight to the scene.

FIG. 3D illustrates a diagram of a shooting direction of the virtual object according to another embodiment of the invention. Since the interaction images are stereoscopic images, the target object 310 may be located at a specific depth from the display screen 240. Generally, the trajectory of the projectile can be a direct line without considering gravity, as illustrated by line 350 in FIG. 3D. The trajectory of the projectile may also be a parabola since a gravity parameter may be considered by the processing unit 230 while shooting the projectile, as illustrated by line 360 in FIG. 3D. In addition, the processing unit 230 may provide some hints to the user on the interaction images. That is, the processing unit 230 may draw the hints, such as the orientation, the position, and the trajectory of the projectile, on the interaction images. Further, the processing unit 230 may also render immersive views (i.e. a panorama) of the scene as if the user is surrounded by a panorama, thereby enhancing the feedback of interactions.

FIG. 3E illustrates a diagram of the target object according to yet another embodiment of the invention. As illustrated in FIG. 3E, the processing unit 230 may recognize a person or an object as the target object (e.g. the window 310) from the interaction image 370. The technologies of object recognition and face recognition are well-known for those skilled in the art, and thus the details will not be described here. In addition, referring to the embodiment in FIG. 3A, the processing unit 230 may draw a virtual object as the target object on the interaction images. Accordingly, the target object can be a real object recognized by the processing unit 230 in the scene or a virtual object drawn by the processing unit 230.

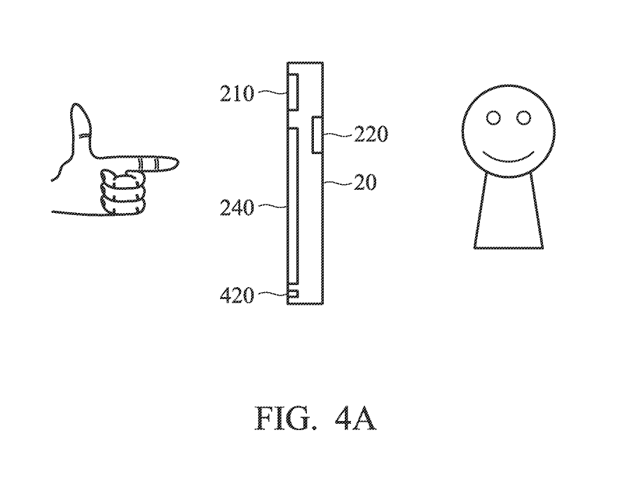

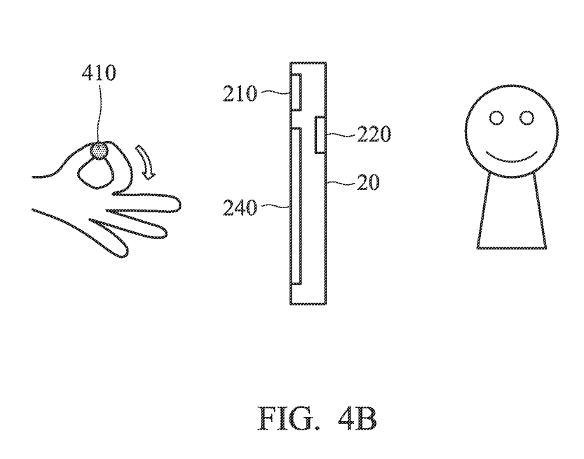

FIGS. 4A-4B illustrate a diagram of the shooting game application according to yet another embodiment of the invention. In yet another embodiment, the projectile in the shooting game application can be shot in various ways. For example, the user's hand may be in a “pistol” shape, wherein the orientation of the forefinger indicates the shooting direction of the projectile. In the embodiment, the mobile device 100 may comprise a microphone 420 coupled to the processing unit 230 for receiving sounds from the user. Accordingly, the processing unit 230 may further control the projectile in the shooting game application by the received sounds of the user (e.g. a specific word such as “BANG”) and the gestures in the captured images from the front-facing camera 210. That is, the processing unit 230 may further compute and create the interactions according to the received sounds and gestures. In yet another embodiment, the user may shoot the projectile by using specific hand/body postures, or facial expressions (e.g. twinkling eyes, smiling, etc.), as illustrated in FIG. 4B. The specific hand postures are similar to the hand postures in FIG. 3A. The processing unit 230 may detect the connected point 410 of the fingertips in the captured images from the front-facing camera 210. When the forefinger quickly moves away from the thumb to throw the projectile, the processing unit 230 may detect the moving speed and the orientation of the forefinger, thereby calculating the trajectory of the projectile in the interaction images. In yet another embodiment, the user may throw the projectile by using the gesture analogous to throwing a dart. The processing unit 230 may detect the moving speed and orientation of the user's hand, thereby calculating the trajectory of the projectile in the interaction images. It should be noted that the application is not limited to the aforementioned embodiments to operate the projectile.

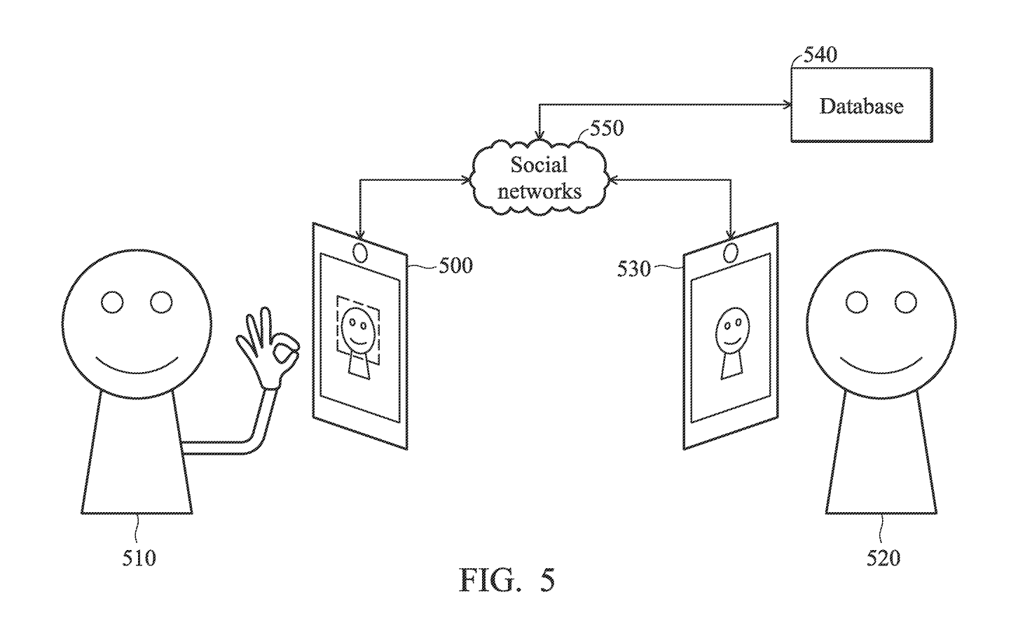

FIG. 5 illustrates a diagram of mobile devices connected with a social network according to an embodiment of the invention. As illustrated in FIG. 5, the user may interact with another user by using the social network. For example, when the user 510 meets a friend (e.g. the user 520) on the buddy list (i.e. friend list) of a social network occasionally, the user 510 may use the mobile device 500 to capture images of the user 520. Meanwhile, the mobile device 500 may perform face recognition to the captured images, so that the user 520 can be recognized as the target object in the interaction images generated by the processing unit of the mobile device 500. The processing unit 230 further builds an interaction status (e.g. the time, the location, the target object, and the interaction behaviors) when the user 510 interacts with the target object (i.e. the user 520) on the interaction images by the gestures. The processing unit 230 may send the interaction status to a database 540 (e.g. an internet server) through the social network 550 (e.g. MSN Messenger, Facebook, Google+, etc.). The database 540 may further transmit the interaction status to a corresponding electronic device 530 (e.g. a personal computer, a mobile device, etc.) of the user 520 through the social network 550, so that the user 520 can be informed that he has been shot by the user 510 at a specific time and location, thereby achieving interactions between the users 510 and 520. In addition, the processing unit 230 may recognize a person or an object as a target object from the second images. The processing unit 230 may further build an interaction status when the user interacts with the target object by gestures, and transmit the interaction status to a database through a social network. For those skilled in the art, it should be appreciated that the invention is not limited to the aforementioned embodiment.

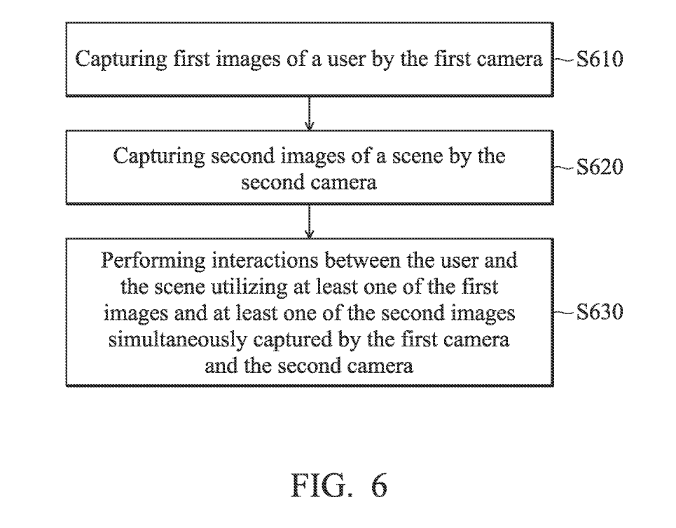

FIG. 6 illustrates an interaction display method applied in the interaction display system of the mobile device according to an embodiment of the invention. In step S610, the front-facing camera 210 (i.e. a first camera) may capture first images of a user. In step S620, the rear-facing camera 220 (i.e. a second camera disposed at an opposite side from the first camera) may capture second images of a scene. In step 630, the processing unit 230 may perform interactions utilizing at least one of the first images and at least one of the second images captured simultaneously by the first camera and the second camera. It should be noted that the front-facing camera 210 and the rear-facing camera 220 can be disposed at different sides (e.g. opposite sides) of the mobile device 20. Alternatively, the front-facing camera 210 and the rear-facing camera 220 may be disposed to face different sides of the mobile device 20. When two cameras are disposed on different sides of a mobile device, it is not limited, as to which one is the front-facing camera or the rear-facing camera. The interaction display system may simultaneously utilize the two cameras disposed on different sides of the mobile device to perform interactions between the user and the scene.

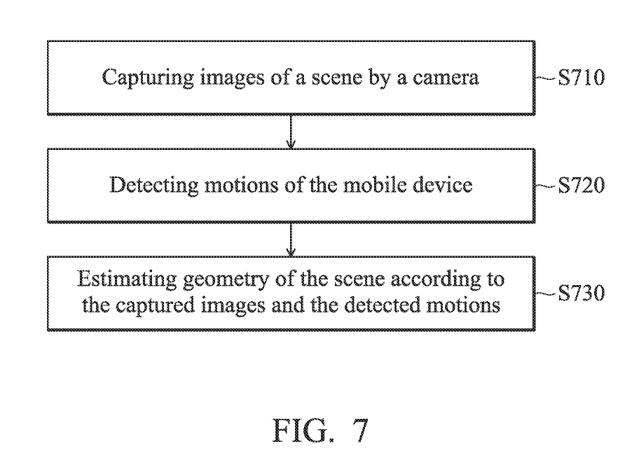

FIG. 7 illustrates an interaction display method applied in the interaction display system of the mobile device according to an embodiment of the invention. Please refer to FIGS. 2B and 7. In step S710, the camera 210 of the mobile device 30 may capture images of a scene. In step 720, the motion detector 250 may detect motions of the mobile device 30. Specifically, the detected motions can be classified as an acceleration and an orientation of the mobile device 30, and the motion detector 250 may comprise an accelerometer 251 and a gyroscope 252, wherein the accelerometer 251 is configured to detect the acceleration of the mobile device 30, and the gyroscope 252 is configured to detect the orientation of the mobile device 30. In step S730, the processing unit 230 may estimate geometry of the scene according to the captured images and the detected motions. It should be noted that the steps in FIG. 7 can be achieved by a mobile device with a single camera. Referring to FIG. 2C, the mobile device may further comprise a second camera (e.g. the front-facing camera 210 in FIG. 2C) to capture images of a user continuously, and the processing unit 230 may further generate interaction images according to the estimated geometry of the scene and the captured images for the user to interact with the scene.

The methods, or certain aspects or portions thereof, may take the form of a program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The methods may also be embodied in the form of a program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An interaction display system applied in a mobile device comprised a camera unit configured to capture images of a scene, the interaction display system comprising:
a motion detection unit configured to detect motions of the mobile device during capturing the images; and
a processing unit coupled to the camera unit and the motion detection unit, configured to estimate a geometry of the scene according to the captured images and the detected motions.

2. The interaction display system as claimed in claim 1, wherein the detected motions comprise an acceleration and an orientation of the mobile device.

3. The interaction display system as claimed in claim 1, wherein the camera unit further captures the images of the scene with a built-in flashlight, and the processing unit estimates the geometry of the scene by calculating the luminance change of the scene caused by the light emitted from the built-in flashlight.

4. The interaction display system as claimed in claim 2, further comprising:
a second camera configured to capture second images of a user, wherein the processing unit further generates interaction images according to the estimated geometry and the captured second images for the user to interact with the scene.

5. An interaction display method applied in an interaction display system of a mobile device, the interaction display system comprising a camera, a motion detection unit, and a processing unit, and the method comprising:
capturing images of a scene by a camera;
detecting motions of the mobile device by the motion detection unit during capturing the images; and
estimating a geometry of the scene according to the captured images and the detected motions.

6. The interaction display method as claimed in claim 5, wherein the step of detected motions of the mobile device further comprises:
detecting the acceleration of the mobile device; and
detecting the orientation of the mobile device.

7. The interaction display method as claimed in claim 5, wherein the step of estimating the geometry of the scene further comprises:
capturing the images of the scene with a built-in flashlight of the mobile device; and
estimating the geometry of the scene by calculating the luminance change of the scene caused by the light emitted from the built-in flashlight.

8. The interaction display method as claimed in claim 5, wherein the camera faces a first side of the mobile device, and the method further comprises:
capturing second images of a user by a second camera, wherein the second camera faces a second side different from the first side of the mobile device; and
generating interaction images according to the estimated geometry and the captured second images for the user to interact with the scene.

9. An interaction display method applied in an interaction display system of a mobile device, the interaction display system comprising a first camera facing a first side of the mobile device, a second camera facing a second side different from the first side of the mobile device, a motion detection unit, and a processing unit, the method comprising:
capturing first images of a user by the first camera;
capturing second images of a scene by the second camera;
detecting first motions of the mobile device by the motion detection unit during capturing the first images and detecting second motions of the mobile device during capturing the second images;
estimating a first geometry of the user according to the first images and the first motions, and estimating a second geometry of the scene according to the second images and the second motions; and
computing and producing interaction results utilizing the estimated first geometry and second geometry, and at least one of the first images and at least one of the second images simultaneously captured by the first camera and the second camera.

10. The interaction display method as claimed in claim 9, wherein the detected motions comprise an acceleration or an orientation of the mobile device.

11. The interaction display method as claimed in claim 9, wherein the processing unit further generates interaction images according to the first images and the second images.

12. The interaction display method as claimed in claim 11, further comprising:
executing a shooting game application by drawing a virtual slingshot on the interaction images; and
computing a power and a shooting direction of a string of the virtual slingshot according to gestures in the first images.

13. The interaction display method as claimed claim 9, further comprising:
recognizing a person or an object as a target object from the second images;
building an interaction status when the user interacts with the target object by gestures; and
transmitting the interaction status to a database through a social network.

14. The interaction display method as claimed in claim 10, wherein at least one of the first camera and the second camera is a stereo camera or a depth camera, and the generated interaction images are stereoscopic images.

15. The interaction display method as claimed in claim 14, further comprising:
outputting the generated interaction images on a stereoscopic display screen.

16. The interaction display method as claimed in claim 9, further comprising:
executing an application;
receiving sounds of the user; and
computing and creating the interactions by using the received sounds and gestures.

17. An interaction display system applied in a mobile device comprised a first camera and a second camera, the first camera faced to a first side of the mobile device and configured to capture first images of a user, and the second camera faced to a second side different from the first side of the mobile device and configured to capture second images of a scene; the interaction display system comprising:
a motion detection unit configured to detect first motions of the mobile device during capturing the first images and detect second motions of the mobile device during capturing the second images and
a processing unit coupled to the first camera, the second camera and the motion detection unit, configured to estimate a first geometry of the user according to the first images and the first motions, estimate a second geometry of the scene according to the second images and the second motions, and compute and produce interaction results utilizing the estimated first geometry and second geometry, and at least one of the first images and at least one of the second images simultaneously captured by the first camera and the second camera.

18. The interaction display system as claimed in claim 17, wherein the processing unit further generates interaction images according to the first images and the second images.

19. The interaction display system as claimed in claim 18, wherein the processing unit further executes a shooting game application by drawing a virtual slingshot on the interaction images, and the processing unit computes power and a shooting direction of a string of the virtual slingshot according to gestures in the first images.

20. The interaction display system as claimed in claim 17, wherein the processing unit further recognize a person or an object as a target object from the second images,
wherein the processing unit further builds an interaction status when the user interacts with the target object by gestures, and
wherein the processing unit further transmits the interaction status to a database through a social network.
